(19) United States
(12) Patent Application Publication
(10) Pub. No.: US 2026/0051524 A1
(43) Pub. Date: Feb. 19, 2026

(54) METHODS OF MAKING A FE-CR ELECTROLYTE AND REDOX FLOW BATTERY SYSTEMS USING THE ELECTROLYTE

(71) Applicant: Cougar Creek Technologies, LLC, KIRKLAND, WA (US)

(72) Inventors: Liyu Li, Bellevue, WA (US); Qingtao Luo, Mukilteo, WA (US)

(21) Appl. No.: 19/296,490

(22) Filed: Aug. 11, 2025

Related U.S. Application Data
(60) Provisional application No. 63/683,635, filed on Aug. 15, 2024.

(51) Int. Cl. H01M 8/18; C01G 37/04; C01G 49/10

(52) U.S. Cl. CPC H01M 8/188; C01G 37/04; C01G 49/10

(57) ABSTRACT

A method of making an Fe—Cr electrolyte includes a) oxidizing a carbon-containing Fe—Cr alloy with Fe₂O₃ or FeO; and b) treating the oxidized carbon-containing Fe—Cr alloy with FeCl₃ or HCl or any combination thereof to produce a FeCl₂—CrCl₃ electrolyte. The method may also include treating, under reducing conditions, a starting material, such as chromite ore, with a carbon source to produce the carbon-containing Fe—Cr alloy. Additionally or alternatively, the method may include removing a portion of the FeCl₂ from the FeCl₂—CrCl₃ electrolyte to obtain a selected iron to chromium molar ratio for the Fe—Cr electrolyte.

### RELATED PATENT APPLICATIONS

The present patent application claims the benefit of U.S. Provisional Patent Application Ser. No. 63/683,635, filed Aug. 15, 2024, which is incorporated herein by reference in its entirety.

### FIELD

The present invention is directed to methods of producing iron-chromium (Fe—Cr) electrolytes. The present invention is also directed to redox flow battery systems that include the Fe—Cr electrolytes made by these methods.

### BACKGROUND

Iron-chromium (Fe—Cr) electrolytes have a variety of uses, for example, as the electrolyte for redox flow batteries. The cost of renewable power generation has reduced rapidly in the past decade and continues to decrease as more renewable power generation elements, such as solar panels, are deployed. However, renewable power sources, such as solar, hydroelectric, and wind sources, are often intermittent and the pattern of user load does not typically coincide with the intermittent nature of the sources. There is a need for an affordable and reliable energy storage system to store power generated by renewable power sources when available and to provide power to users when there is insufficient power generation from the renewable power sources.

### BRIEF SUMMARY

One embodiment is a method of making an Fe—Cr electrolyte that includes a) oxidizing a carbon-containing Fe—Cr alloy with Fe₂O₃ or FeO; and b) treating the oxidized carbon-containing Fe—Cr alloy with FeCl₃ or HCl or any combination thereof to produce a FeCl₂—CrCl₃ electrolyte.

In at least some embodiments, the method further includes removing a portion of the FeCl₂ from the FeCl₂—CrCl₃ electrolyte to obtain a selected iron to chromium molar ratio for the Fe—Cr electrolyte. In at least some embodiments, removing the portion of the FeCl₂ including using evaporation to remove the portion of the FeCl₂. In at least some embodiments, the method further includes oxidizing at least part of the removed portion of the FeCl₂ to produce FeCl₃. In at least some embodiments, the method further includes repeating steps a) and b) utilizing the FeCl₃ produced by the oxidation of at least part of the removed portion of the FeCl₂ for the treatment of oxidized carbon-containing Fe—Cr alloy during the repeated step b).

In at least some embodiments, the method further includes treating, under reducing conditions, a starting material with a carbon source to produce the carbon-containing Fe—Cr alloy, wherein the starting material includes iron and chromium. In at least some embodiments, the carbon source includes at least one of graphite, coal, activated carbon, charcoal, carbon monoxide gas, or a carbon-containing material containing carbon with an oxidation state less than +4. In at least some embodiments, treating the starting material includes treating the starting material at a temperature of at least 1400° C. In at least some embodiments, the starting material includes chromite ore.

In at least some embodiments, oxidizing the carbon-containing Fe—Cr alloy includes oxidizing the carbon-containing Fe—Cr alloy at a temperature of at least 1400° C. In at least some embodiments, oxidizing the carbon-containing Fe—Cr alloy includes oxidizing the carbon-containing Fe—Cr alloy with Fe₂O₃.

In at least some embodiments, treating the oxidized carbon-containing Fe—Cr alloy includes treating the oxidized carbon-containing Fe—Cr alloy with FeCl₃. In at least some embodiments, treating the oxidized carbon-containing Fe—Cr alloy includes treating the oxidized carbon-containing Fe—Cr alloy with HCl.

In at least some embodiments, the method further includes adding a nitrogen-containing or sulfur-containing complex or chelating agent to remove one or more of Ni, Bi, Cu, or Zn by precipitation. In at least some embodiments, the nitrogen-containing or sulfur-containing complex or chelating agent includes at least one of sodium dimethyldithiocarbamate (SDDC), sodium diethyldithiocarbamate (SEDTC), or sodium ethylenediamine dithiocarbamate (EDTC), polydithiocarbamate (PDTC).

In at least some embodiments, treating the oxidized carbon-containing Fe—Cr alloy includes adding an iron-containing or chromium-containing material to obtain a selected iron to chromium molar ratio. In at least some embodiments, the iron-containing or chromium-containing material includes at least one of FeCl₂—4H₂O or CrCl₃—6H₂O.

In at least some embodiments, the method further includes evaporating the FeCl₂—CrCl₃ electrolyte to produce at least crystals of FeCl₂ and CrCl₃. In at least some embodiments, the method further includes solvating the crystals of FeCl₂ and CrCl₃.

Another embodiment is a redox flow battery system including an anolyte; a catholyte, wherein at least one of the anolyte or the catholyte includes the Fe—Cr electrolyte made using any of the methods described above; a first electrode; a first half-cell in which the first electrode is in contact with the anolyte; a second half-cell in which the second electrode is in contact with the catholyte; and a separator between the first and second half-cells.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic diagram of one embodiment of a redox flow battery system, according to the invention.

### DETAILED DESCRIPTION

The present invention is directed to methods of producing iron-chromium (Fe—Cr) electrolytes. The present invention is also directed to redox flow battery systems that include the Fe—Cr electrolytes made by these methods.

An Fe—Cr electrolyte can include an iron-containing compound and a chromium-containing compound (or both) dissolved in a solvent. Any suitable starting material can be used to prepare an Fe—Cr electrolyte including, but not limited to, iron and chromium containing materials or mixtures, such as, but not limited to, any material that includes an iron oxide, a chromium oxide, or any iron chromium oxide, or the like or any combination thereof. chromite ore. As an example, chromite ore can be a starting point for making the Fe—Cr electrolyte, but it will be understood that the methods described herein can be used for making the Fe—Cr electrolyte from other suitable materials. Chromite ore has the chemical formula FeCr₂O₄ and a theoretical composition of 32.0% FeO and 68.0% Cr₂O₃.

Chromite ore (or other suitable material) is treated under high temperature and reducing conditions, and in the presence of a carbon source, to convert the chromite ore to a carbon-containing Fe—Cr alloy. In at least some embodiments, the carbon source acts as a reducing agent. In at least some embodiments, the treatment temperature is at least 1400° C., 1500° C., or 1600° C. In at least some embodiments, the oxygen partial pressure is no more than 10⁻¹⁰ Pa, 10⁻¹² Pa, or 10⁻¹⁴ Pa. Examples of suitable carbon sources include, but are not limited to, graphite, coal, activated carbon, charcoal, carbon monoxide gas, and carbon-containing materials containing carbon with an oxidation state less than +4 which can remove oxygen from the chromite ore as carbon monoxide or carbon dioxide. In at least some embodiments, the carbon content in the carbon-containing Fe—Cr alloy is in a range of 2 to 10 wt. %. In at least some embodiments, the resulting carbon-containing Fe—Cr alloy includes one or more impurities, such as, for example, SiO₂, Al₂O₃, MgO, CaO, or the like or any combination thereof.

At least some of the carbon in the carbon-containing Fe—Cr alloy is subsequently oxidized at a high temperature by adding Fe₂O₃ or FeO or any combination thereof. In at least some embodiments, the temperature is at least 1400° C., 1500° C., or 1600° C. In at least some embodiments, the duration of this treatment is at least 10 minutes, 30 minutes, or 1 hour. In at least some embodiments, Fe₂O₃ or FeO is added in higher than stoichiometric amounts to facilitate more carbon removal.

The resulting low-carbon Fe—Cr material is then treated with a solution of FeCl₃ solution to dissolve the Fe—Cr material. Although not necessary to the invention, it is thought that this occurs, at least in part, via following reactions:

Cr+3FeCl₃→CrCl₃+3FeCl₂

Fe+2FeCl₃→FeCl₂+2FeCl₂

Alternatively or additionally, the low-carbon Fe—Cr material is treated with HCl to dissolve the low-carbon Fe—Cr material, as well as any Fe₂O₃ or FeO, which, for example, was not fully used during the carbon-removal process. HCl can be used to dissolve these iron oxides. Although not necessary to the invention, it is thought that this occurs, at least in part, via following reactions:

2Cr—Fe+10HCl→2CrCl₃+2FeCl₂+5H₂

Fe₂O₃+6HCl→2FeCl₃+3H₂O (with subsequent reduction of FeCl₃ to FeCl₂)

FeO+2HCl→FeCl₂+H₂O)

Next one or more nitrogen-containing and/or sulfur-containing complexes or chelating agents or the like or any combination thereof are added to remove cations (e.g., hydrogenation catalyst cations), such as Ni, Bi, Cu, and Zn cations. In at least some embodiments, these cations may have been dissolved into solution during preceding steps. Examples of such complexes or chelating agents include, but are not limited, to sodium dimethyldithiocarbamate (SDDC), sodium diethyldithiocarbamate (SEDTC), sodium ethylenediamine dithiocarbamate (EDTC), polydithiocarbamate (PDTC), or the like or any combination thereof.

Solid particles are separated and removed to leave a solution that contains FeCl₂, CrCl₃, and some soluble impurities such as, for example, NaCl and KCl. The solid particles are discarded.

One or more evaporation or crystallization techniques (or combinations thereof or any other suitable techniques) are used to remove any excess FeCl₂ as a solid salt in order to produce an electrolyte solution with a desired FeCl₂—CrCl₃ composition (e.g., a desired molar ratio of iron to chromium in the electrolyte solution). For example, the iron to chromium molar ratio can be monitored during evaporation. In at least some embodiments, when the molar concentration of FeCl₂ is greater than CrCl₃, FeCl₂ crystallizes faster than CrCl₃. When the desired iron to chromium molar ratio is achieved in solution, the FeCl₂ crystals are removed leaving a solution with the desired iron to chromium molar ratio. (This step may be moot if the solution already has the desired iron to chromium molar ration.) In at least some embodiments, the iron to chromium molar ratio can be further modified by the addition of crystals or solutions of FeCl₂—4H₂O or CrCl₃—6H₂O or the like or any combination thereof.

The removed FeCl₂ crystals can be oxidized to FeCl₃ using, for example, HCl, as well as air, oxygen, or H₂O₂ or the like or any combination thereof. The resulting FeCl₃ can be reused as a reactant in the treatment of the low carbon Fe—Cr material, described above.

Optionally, the FeCl₂—CrCl₃ electrolyte solution can be further evaporated to produce a solid containing FeCl₂ and CrCl₃ (e.g., mixed crystals of FeCl₂ and CrCl₃). These crystals may be useful for on-site electrolyte preparation, for example, for a Fe—Cr flow battery.

As an example of use, an Fe—Cr electrolyte can be used as the anolyte or catholyte or both analyte and catholyte of a redox flow battery. The iron to chromium molar ratio in the anolyte and catholyte can be the same or different.

Redox flow battery systems are a promising technology for the storage of energy generated by renewable energy sources, such as solar, wind, and hydroelectric sources, as well as non-renewable and other energy sources. As described herein, in at least some embodiments, a redox flow battery system can have one or more of the following properties: long life; reusable energy storage; or tunable power and storage capacity.

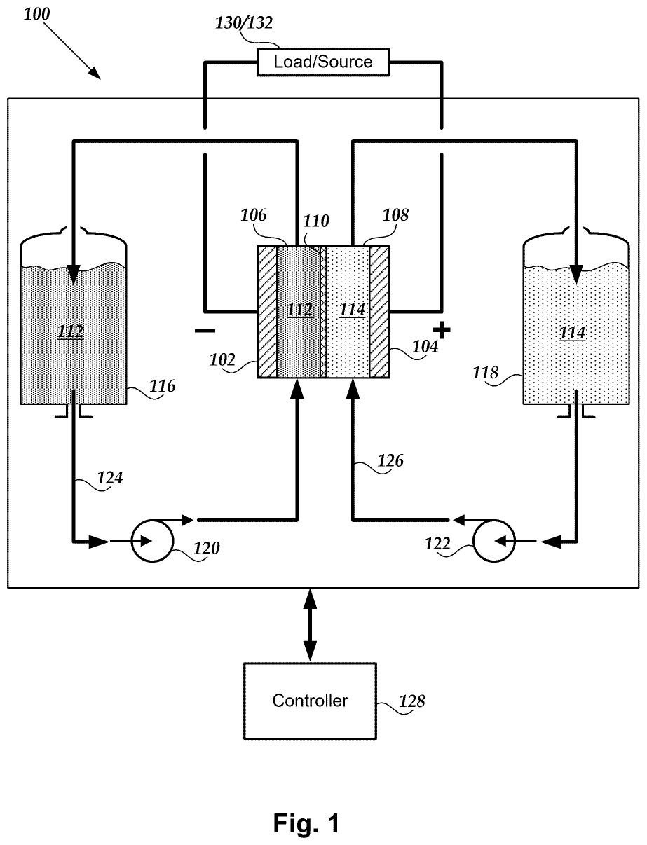

FIG. 1 illustrates one embodiment of a redox flow battery system 100. It will be recognized that other redox flow battery systems 100 may include more or fewer elements and the elements may be arranged differently than shown in the illustrated embodiments. It will also be recognized that the description below of components, methods, systems, and the like can be adapted to other redox flow battery systems different from the illustrated embodiments.

The redox flow battery system 100 of FIG. 1 includes two electrodes 102, 104 and associated half-cells 106, 108 that are separated by a separator 110. The electrodes 102, 104 can be in contact or separated from the separator. Electrolyte solutions flow through the half-cells 106, 108 and are referred to as the anolyte 112 and the catholyte 114. The redox flow battery system 100 further includes an anolyte tank 116, a catholyte tank 118, an anolyte pump 120, a catholyte pump 122, an anolyte distribution arrangement 124, and a catholyte distribution arrangement 126. The anolyte 112 is stored in the anolyte tank 116 and flows around the anolyte distribution arrangement 124 through, at least in part, action of the anolyte pump 120 to the half-cell 106. The catholyte 114 is stored in the catholyte tank 118 and flows around the catholyte distribution arrangement 126 through, at least in part, action of the catholyte pump 122 to the half-cell 108. It will be recognized that, although the illustrated embodiment of FIG. 1 includes a single one of each of the components, other embodiments can include more than one of any one or more of the illustrated components. For example, other embodiments can include multiple electrodes 102, multiple electrodes 104, multiple anolyte tanks 116, multiple catholyte tanks 118, multiple half-cells 112, or multiple half-cells 114, or any combination thereof.

During energy flow into or out of the redox flow battery system 100, the electrolyte in one of the half-cells 106, 108 is oxidized and loses electrons and the electrolyte in the other one of the half-cells is reduced and gains electrons. The redox flow battery system 100 can be attached to a load/source 130/132, as illustrated in FIG. 1. In a charge mode, the redox flow battery system 100 can be charged or recharged by attaching the flow battery to a source 132. The source 132 can be any power source including, but not limited to, fossil fuel power sources, nuclear power sources, other batteries or cells, and renewable power sources, such as wind, solar, or hydroelectric power sources. In a discharge mode, the redox flow battery system 100 can provide energy to a load 130.

In the charge mode, the redox flow battery system 100 converts electrical energy from the source 132 into chemical potential energy. In the discharge mode, the redox flow battery system 100 converts the chemical potential energy back into electrical energy that is provided to the load 130.

The redox flow battery system 100 can also be coupled to a controller 128 that can control operation of the redox flow battery system. For example, the controller 128 may connect or disconnect the redox flow battery system 100 from the load 130 or source 132. The controller 128 may control operation of the anolyte pump 120 and catholyte pump 122. The controller 128 may control operation of valves associated with the anolyte tank 116, catholyte tank 118, anolyte distribution system 124, catholyte distribution system 126, or half-cells 106, 108. The controller 128 may be used to control general operation of the redox flow battery system 100 include switching between charge mode, discharge mode, and, optionally, a maintenance mode (or any other suitable modes of system operation.)

Any suitable controller 128 can be used including, but not limited to, one or more computers, laptop computers, servers, any other computing devices, or the like or any combination thereof and may include components such as one or more processors, one or more memories, one or more input devices, one or more display devices, and the like. The controller 128 may be coupled to the redox flow battery system through any wired or wireless connection or any combination thereof. The controller 128 (or at least a portion of the controller) may be located local to the redox flow battery system 100 or located, partially or fully, non-locally with respect to the redox flow battery system.

The electrodes 102, 104 can be made of any suitable material including, but not limited to, graphite or other carbon materials (including solid, felt, paper, or cloth electrodes made of graphite or carbon), gold, titanium, lead, or the like. Additional examples of electrodes can be found in the references cited above. The two electrodes 102, 104 can be made of the same or different materials. In at least some embodiments, the redox flow battery system 100 does not include any homogenous or metallic catalysts for the redox reaction in the anolyte or catholyte or both. This may limit the type of material that may be used for the electrodes.

The separator 110 separates the two half-cells 106, 108. In at least some embodiments, the separator 110 allows the transport of selected ions (for example, H⁺, Cl⁻, or iron or chromium ions or any combination thereof) during the charging or discharging of the redox flow battery system 100. In some embodiments, the separator 110 is a microporous membrane. Any suitable separator 110 can be used and examples of suitable separator include, but are not limited to, ion transfer membranes, anionic transfer membranes, cationic transfer membranes, microporous separators, or the like or any combination thereof.

In at least some embodiments, the molarity of iron in the catholyte or the anolyte or both is in a range of 0.5 to 2 or is at least 1 M. In at least some embodiments, the molarity of chromium in the anolyte or the catholyte or both is in a range of 0.1 to 2 or is at least 0.2, 0.5, or 1 M. In at least some embodiments, the molarity of the hydrochloric acid or other aqueous acid or base in the electrolyte is in a range of 0.5 to 2. The anolyte and catholyte can have the same iron to chromium molar ratio or that molar ratio can be different for the anolyte and catholyte.

The anolyte and catholyte tanks 116, 118 are referred to as electrolyte tanks. Any suitable tank can be used for the anolyte and catholyte tanks 116, 118 including commercial electrolyte tanks and other known designs of electrolyte tanks.

Examples of redox flow battery systems and methods of using and making such systems are disclosed in U.S. Pat. Nos. 10,777,836; 10,826,102; 11,189,854; 11,201,345; 11,233,263; 11,626,608; 11,710,844; 11,735,756; 11,764,385; 11,955,677; and 11,990,659; and U.S. Patent Application Publications Nos. 2022/0158212; 2023/0231171; 2023/0282861; and 2024/0266575, all of which are incorporated herein by reference in their entireties. The redox flow battery systems and methods disclosed herein can be modified to include any of the components, methods, techniques, or the like described in these cited references or used in the methods described in these cited references. The Fe—Cr electrolyte described herein can be used in the redox flow batteries described in the cited references.

### EXAMPLE 1

50 grams of the high-carbon Fe—Cr alloy powder (which is commercially available from a variety of suppliers) was mixed with 35 grams of Fe₂O₃. The mixture was heated at 1700° C. in a vacuum oven for 1 hour to obtain a low-carbon Fe—Cr alloy with some remaining Fe₂O₃. This mixture was dissolved using 250 ml concentrated HCl at ambient temperature until pH>0.5.

Approximately 3 gram of a commercial nickel-removal agent with a sulfide function group (sodium diethyldithiocarbamate—NaDDC) was added to the solution to remove nickel, resulting in a nickel concentration of no more than 10 ppm. After filtration to remove solid particles, the solution was evaporated and a solid sample with FeCl₂ and CrCl₃ was obtained. The iron/chromium ratio of the sample was at a desired level and so no further processing was required.

The above specification provides a description of the manufacture and use of the invention. Since many embodiments of the invention can be made without departing from the spirit and scope of the invention, the invention also resides in the claims hereinafter appended.

What is claimed as new and desired to be protected is:

1. A method of making an Fe—Cr electrolyte, the method comprising:
a) oxidizing a carbon-containing Fe—Cr alloy with Fe₂O₃ or FeO; and
b) treating the oxidized carbon-containing Fe—Cr alloy with FeCl₃ or HCl or any combination thereof to produce a FeCl₂—CrCl₃ electrolyte.

2. The method of claim 1, further comprising removing a portion of the FeCl₂ from the FeCl₂—CrCl₃ electrolyte to obtain a selected iron to chromium molar ratio for the Fe—Cr electrolyte.

3. The method of claim 2, wherein removing the portion of the FeCl₂ comprising using evaporation to remove the portion of the FeCl₂.

4. The method of claim 3, further comprising oxidizing at least part of the removed portion of the FeCl₂ to produce FeCl₃.

5. The method of claim 4, further comprising repeating steps a) and b) utilizing the FeCl₃ produced by the oxidation of at least part of the removed portion of the FeCl₂ for the treatment of oxidized carbon-containing Fe—Cr alloy during the repeated step b).

6. The method of claim 1, further comprising treating, under reducing conditions, a starting material with a carbon source to produce the carbon-containing Fe—Cr alloy, wherein the starting material comprises iron and chromium.

7. The method of claim 6, wherein the carbon source comprises at least one of graphite, coal, activated carbon, charcoal, carbon monoxide gas, or a carbon-containing material containing carbon with an oxidation state less than +4.

8. The method of claim 6, wherein treating the starting material comprises treating the starting material at a temperature of at least 1400° C.

9. The method of claim 8, wherein the starting material comprises chromite ore.

10. The method of claim 1, wherein oxidizing the carbon-containing Fe—Cr alloy comprises oxidizing the carbon-containing Fe—Cr alloy at a temperature of at least 1400° C.

11. The method of claim 1, wherein oxidizing the carbon-containing Fe—Cr alloy comprises oxidizing the carbon-containing Fe—Cr alloy with Fe₂O₃.

12. The method of claim 1, wherein treating the oxidized carbon-containing Fe—Cr alloy comprises treating the oxidized carbon-containing Fe—Cr alloy with FeCl₃.

13. The method of claim 1, wherein treating the oxidized carbon-containing Fe—Cr alloy comprises treating the oxidized carbon-containing Fe—Cr alloy with HCl.

14. The method of claim 1, further comprising adding a nitrogen-containing or sulfur-containing complex or chelating agent to remove one or more of Ni, Bi, Cu, or Zn by precipitation.

15. The method of claim 14, wherein the nitrogen-containing or sulfur-containing complex or chelating agent comprises at least one of sodium dimethyldithiocarbamate (SDDC), sodium diethyldithiocarbamate (SEDTC), or sodium ethylenediamine dithiocarbamate (EDTC), polydithiocarbamate (PDTC).

16. The method of claim 1, wherein treating the oxidized carbon-containing Fe—Cr alloy comprises adding an iron-containing or chromium-containing material to obtain a selected iron to chromium molar ratio.

17. The method of claim 16, wherein the iron-containing or chromium-containing material comprises at least one of FeCl₂—4H₂O or CrCl₃—6H₂O.

18. The method of claim 1, further comprising evaporating the FeCl₂—CrCl₃ electrolyte to produce at least crystals of FeCl₂ and CrCl₃.

19. The method of claim 18, further comprising solvating the crystals of FeCl₂ and CrCl₃.

20. A redox flow battery system, comprising:
an anolyte;
a catholyte, wherein at least one of the anolyte or the catholyte comprises the Fe—Cr electrolyte made using the method of claim 1;
a first electrode;
a first half-cell in which the first electrode is in contact with the anolyte;
a second half-cell in which the second electrode is in contact with the catholyte; and
a separator between the first and second half-cells.
